(19) United States
(12) Patent Application Publication
(10) Pub. No.: US 2005/0038919 A1
(43) Pub. Date: Feb. 17, 2005

(54) User-friendly image forming apparatus and image forming method

(75) Inventors: Masatomo Matsubara, Toyohashi-shi (JP); Kazuhiro Tomiyasu, Hoi-gun (JP); Jiro Goto, Hoi-gun (JP); Toru Maegawa, Hino-shi (JP)

Correspondence Address: Barry E. Bretschneider;Morrison & Foerster LLP, Suite 300, 1650 Tysons Boulevard, McLean, VA, 22102, US

(73) Assignee: Konica Minolta Business technologies, Inc., Chiyoda-ku (JP)

(21) Appl. No.: 10/721,595

(22) Filed: Nov. 26, 2003

(30) Foreign Application Priority Data
Aug. 12, 2003 (JP) 2003-292420
Aug. 12, 2003 (JP) 2003-292423

(51) Int. Cl. G06F 3/00

(52) U.S. Cl. 710/1

(57) ABSTRACT

An image forming apparatus accepts setting related to scanning of documents and setting of a destination of image-related information including thumbnail images, and stores image data obtained by scanning. Further, the image forming apparatus produces the image-related information including the thumbnail images from the image data, and sends it to a personal computer being the set destination. The personal computer displays the thumbnail images, and instruction of an output form of the image data is provided to the image forming apparatus by using the thumbnail image. The image forming apparatus outputs the stored image data in the output form instructed by the personal computer.

This application is based on Japanese Patent Applications Nos. 2003-292420 and 2003-292423 filed with Japan Patent Office on Aug. 12, 2003, the entire content of which is hereby incorporated by reference.

### BACKGROUND OF THE INVENTION

1. Field of the Invention

The present invention relates to an image forming apparatus, an image forming method and an image managing apparatus, and particularly to an image forming apparatus, an image forming method and an image managing apparatus, which are user-friendly.

2. Description of the Related Art

In accordance with development of networks, such use environments have been increasing that an image forming apparatus such as a copying machine or a MFP (Multi-Function Peripheral) is connected to a plurality of computers over a network. For adapting to such use environments, it has been proposed in recent years to use an image forming apparatus, which includes a storage device such as a HDD (Hard Disc Drive) of a large capacity, and is configured to hold image data obtained by scanning for using the data by computers over a network. For the use in such a manner, the image data held in the image forming apparatus is visually displayed as thumbnails for instruction and operation.

For example, Japanese Laid-Open Patent Publication No. 2001-282476 has disclosed a data processing apparatus and a printer control apparatus, in which a host computer obtains and displays thumbnail information corresponding to a print job held in a printer, and a user can designate a print operation after visually checking or confirming the thumbnail information on the host computer.

Also, Japanese Laid-Open Patent Publication No. 2002-183832 has disclosed an image output system, in which an image output apparatus displays, on its screen, thumbnail images representing images of respective pages of a file to be print, and a user can designate an output form on a page-by-page basis.

Japanese Laid-Open Patent Publication No. 2002-305649 has disclosed an image forming apparatus, which produces thumbnail images from a region within image data obtained by scanning original documents, and allows management of stored documents by using the thumbnails thus produced.

According to the image forming apparatuses equipped with technologies disclosed in the foregoing references, a predetermined computer is operated for instructing output of each document from the image data, which was obtained by scanning with the image forming apparatus. For this output instructing operation, however, the following procedures are required. Thus, after the scanning with the image forming apparatus, the computer must access the image forming apparatus to obtain thumbnail images, and then the output instructing operation is performed for each document. These procedures impede the usability.

Further, obtained thumbnail images may be unclear, or a failure may occur when obtaining thumbnail images. In these cases, an operator must operate the image forming apparatus again to prepare thumbnail images. Thereafter, the computer obtains the thumbnail images by accessing the image forming apparatus, and the output instructing operation for each document is performed. These procedures require much time and labor.

### SUMMARY OF THE INVENTION

Accordingly, an object of the invention is to provide an image forming apparatus, an image forming method and an image managing apparatus, which are user-friendly

According to the invention, the above object is achieved by an image forming apparatus including the following components. Thus, the image forming apparatus includes a holding portion holding obtained image data; an image-related information producing portion producing image-related information related to the image data; an accepting portion accepting designation of a destination of the image-related information to be sent; a sending portion sending the image-related information to an external device at the designated destination; a receiving portion receiving output form instruction information related to the image data from the external device; and an image forming portion forming image data for output from the image data held by the holding portion based on the output form instruction information.

According to another aspect of the invention, an image forming apparatus includes a holding portion holding obtained image data; an accepting portion accepting a setting from an external device, said setting being related to an abbreviated image prepared from the image data; an abbreviated image producing portion producing the abbreviated image by using at least a part of the image data based on the setting; and a sending portion sending the abbreviated image to the external device.

According to still another aspect of the invention, an image forming method includes a storing step of storing obtained image data in a storage device by an image forming apparatus; an image-related information producing step of producing image-related information related to the image data in the image forming apparatus; a designating step of designating to the image forming apparatus, a destination of the image-related information to be sent; an image-related information sending step of sending the image-related information to an image managing apparatus at the designated destination from the image forming apparatus; an image-related information displaying step of displaying, in the image managing apparatus, the image-related information received from the image forming apparatus; an output form instruction information producing step of producing, in the image managing apparatus, output form instruction information related to the image data; an output form instruction information sending step of sending the output form instruction information from the image managing apparatus to the image forming apparatus; and an image forming step of forming image data for output from the image data stored in the storage device based on the output form instruction information.

According to yet another aspect of the invention, an image forming method includes a storing step of storing obtained image data in a storage device by an image forming apparatus; a setting step of effecting a setting related to an abbreviated image to be produced from the image data on the image forming apparatus by an image managing apparatus; an abbreviated image producing step of producing, in the image forming apparatus, the abbreviated image by using at least a part of the image data based on the setting; and a sending step of sending the abbreviated image from the image forming apparatus to the image managing apparatus.

According to further another aspect of the invention, an image forming method includes a storing step of storing obtained image data in a storage device by an image forming apparatus; a first abbreviated image producing and sending step of producing a first abbreviated image by using at least a part of the image data, and sending the first abbreviated image from the image forming apparatus to an image managing apparatus; an instructing step of sending an instruction related to the first abbreviated image from the image managing apparatus to the image forming apparatus; and a second abbreviated image producing and sending step of producing, in the image forming apparatus, a second abbreviated image to be substituted for the first abbreviated image by using at least a part of the image data based on the instruction, and sending the second abbreviated image.

According to a further aspect of the invention, an image managing apparatus includes a receiving portion receiving image-related information related to image data from an image forming apparatus; a display portion displaying the image-related information; an output form instruction information producing portion producing output form instruction information instructing an output form of the image data held in the image forming apparatus based on the image-related information; and a sending portion sending the output form instruction information to the image forming apparatus.

According to a further aspect of the invention, an image managing apparatus includes a receiving portion receiving an abbreviated image produced by using at least a part of image data from an image forming apparatus; and a sending portion sending instruction information providing an instruction related to the abbreviated image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a specific example of a structure of an image forming system according to an embodiment.

FIG. 2 illustrates a specific example of a functional structure of an image forming apparatus 100.

FIG. 3 illustrates a specific example of a structure of panel input information.

FIG. 4 illustrates a specific example of a structure of image-related information.

FIG. 5 illustrates a specific example of a structure of output form instruction information.

FIG. 6 is a flowchart illustrating processing in an image forming system.

FIG. 7 is a flowchart illustrating setting input processing.

FIG. 8 is a flowchart illustrating image reading and storing processing.

FIG. 9 is a flowchart illustrating thumbnail producing and sending processing.

FIG. 10 is a flowchart illustrating output processing.

FIG. 11 illustrates a specific example of image-related information.

FIG. 12 illustrates a specific example of image-related information.

FIGS. 13A-13D illustrate specific examples of display screen of a display device 28 in a personal computer 200.

FIGS. 14 to 16 illustrate specific examples of output form instruction information.

FIG. 17 schematically illustrates a result of print output of an image forming apparatus 100.

### DESCRIPTION OF THE PREFERRED EMBODIMENTS

Embodiments of the invention will now be described with reference to the drawings. In the following description, the same parts and components bear the same reference numbers and the same names, and achieve the same functions. Therefore, description thereof is not repeated.

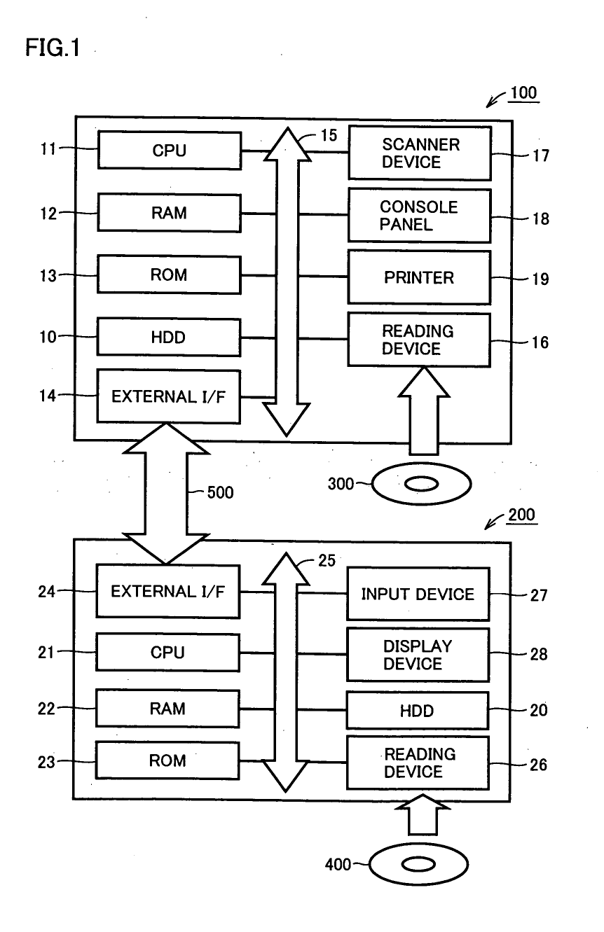

FIG. 1 illustrates a specific example of a structure of an image forming system according to an embodiment. The image forming system according to the embodiment includes an image forming apparatus 100 such as a copying machine or a MFP (Multi-Function Peripheral) and a personal computer 200, which is an external device connected to image forming apparatus 100 over a network 500. The personal computer may be referred to as “PC” in the drawings. FIG. 1 illustrates a specific example of hardware structures of image forming apparatus 100 and personal computer 200.

Network 500 may be a cable communication network formed of dedicated lines such as LAN (Local Area Network) or a public switched telephone network such as the Internet, and also may be a wireless communication network performing infrared communication or the like.

Referring to FIG. 1, image forming apparatus 100 includes a CPU (Central Processing Unit) 11 controlling whole image forming apparatus 100, a HDD (Hard Disc Drive) 10, which is a storage device, a RAM (Random Access Memory) 12, a ROM (Read Only Memory) 13, an external I/F (interface) 14 for connection to personal computer 200 over network 500, a scanner device 17 reading original documents, a console panel 18 formed of a touch panel, a printer 19 printing and outputting image data, and a reading device 16 reading a record medium 300. These are connected to a bus 15.

Console panel 18 is an interface for operation by a user, and is formed of keys, LEDs (Light Emitting Diodes), a LCD (Liquid Crystal Display) and a touch panel. When console panel 18 accepts a user's instruction, console panel 18 issues an instructing signal to CPU 11 via bus 15. Based on the received instructing signal, CPU 11 reads and executes a program recorded in ROM 13 or record medium 300, which can be read by reading device 16. Thereby, CPU 11 provides control signals to various portions. RAM 12 provides a work area for the above operations.

Scanner device 17 reads images of original documents with a CCD (Charge Coupled Device) in accordance with the control signal sent from CPU 11, and converts it to digital image data. Scanner device 17 emits light to an original document from a light source lamp, and receives reflected light via mirror lenses by the CCD arranged in a line fashion to obtain a one-dimensional image in a primary scanning direction. Further, scanning is performed by moving the light source lamp in a secondary scanning direction along the original document to obtain a two-dimensional image.

Image processing is effected on the image data provided from scanner device 17. The image data thus processed is stored in a predetermined region of HDD 10, is output to an external device via external interface 14 or is printed by printer 19. Similar processing is also effected on the image data, which is read from record medium 300 by reading device 16, as well as the image data obtained from an external device such as personal computer 200 via external interface 14 and the image data already obtained and stored in HDD 10.

Printer 19 outputs two-dimensional images by performing raster scanning on a photosensitive drum with laser beams by a polygon mirror.

Personal computer 200 is formed of a CPU 21 entirely controlling personal computer 200, a HDD 20, a RAM 22, and a ROM 23, i.e., storage device, an external interface 24 for connection to image forming apparatus 100 over network 500, an input device 27 formed of a keyboard and a mouse for entering instructions and information, a display device 28 formed of a LCD or the like for displaying information, and a reading device 26 reading a record medium 400. These are connected to a bus 25.

When input device 27 accepts a user's instruction, input device 27 issues an instruction signal to CPU 21 via bus 25. Based on the instructing signal thus supplied, CPU 21 reads and executes a program recorded on record medium 400, which can be read by reading device 26. Thereby, CPU 21 issues control signals to various portions. RAM 22 provides a work area for the above operations.

Naturally, the hardware structures of image forming apparatus 100 and personal computer 200 illustrated in FIG. 1 are the same as those of conventional image forming apparatuses and personal computers, and apparatuses and devices included in the image forming system according to the invention are not restricted to the hardware structures described above. Personal computer 200 is an image managing apparatus having a function of managing the image data held in image forming apparatus 100. The image managing apparatus is not restricted to the personal computer, and may be formed of another apparatus such a portable terminal (e.g., a cellular phone).

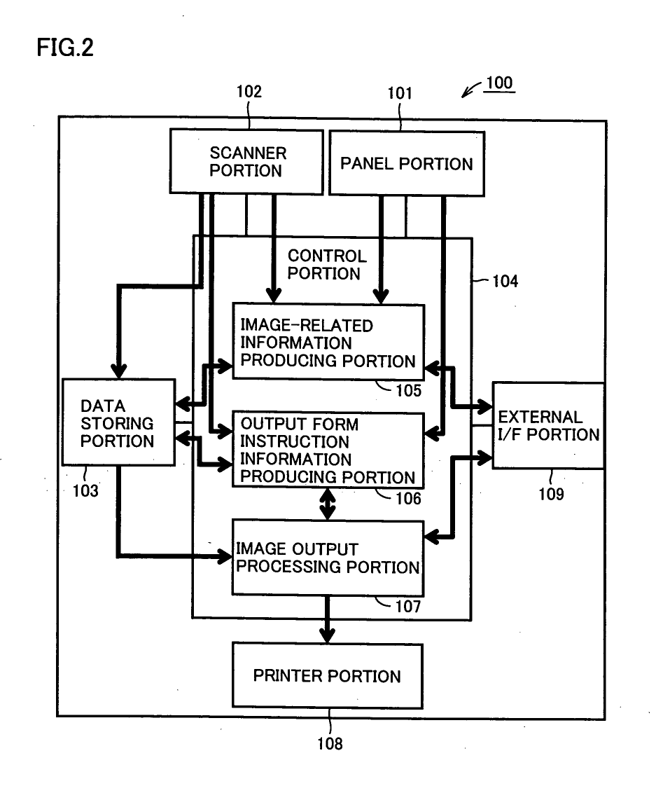

FIG. 2 illustrates a specific example of a functional structure of image forming apparatus 100. Portions illustrated in FIG. 2 represent functions achieved by CPU 11 reading and executing programs stored in ROM 13 or the like.

Referring to FIG. 2, image forming apparatus 100 according to an embodiment includes a panel portion 101 formed of console panel 18, a scanner portion 102 formed of scanner device 17 reading original documents, a control portion 104 formed of CPU 11 and others for achieving various functions of image forming apparatus 100, a data storing portion 103 formed of HDD 10 for storing the image data, image-related information producing portion 105, output form instruction information producing portion 106, image output processing portion 107, a printer portion 108 formed of printer 19 printing the image data, and an external interface portion 109 formed of external interface 24 and others for communication with personal computer 200 (i.e., the external device). In FIG. 2, thick solid lines with arrows indicate flow of data.

Panel portion 101 accepts user's operations. Based on the user's operation thus accepted, panel portion 101 sends panel input information to control portion 104, which provides it to image-related information producing portion 105 and output form instruction information producing portion 106.

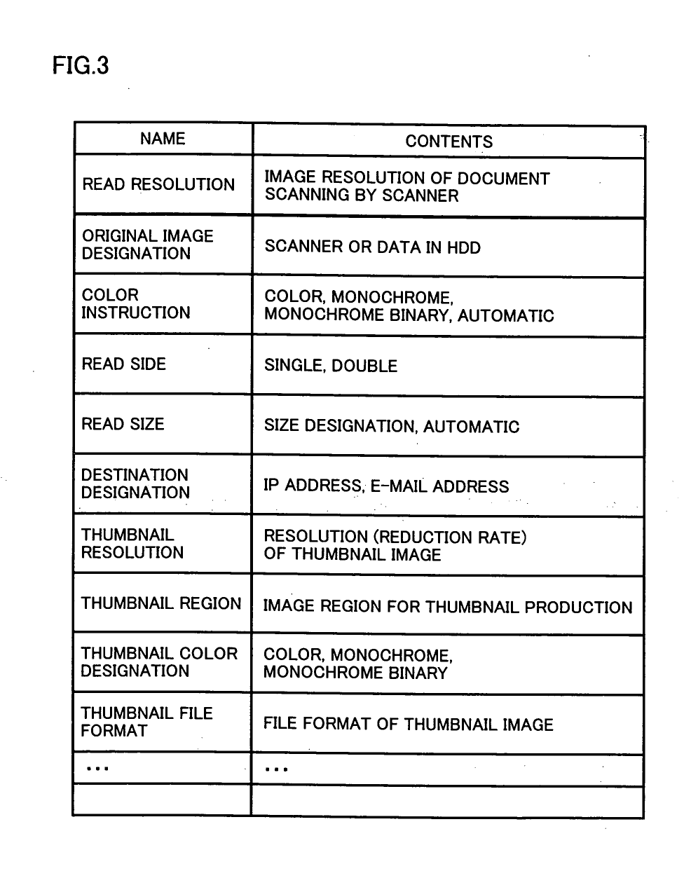

Panel input information is setting information entered via panel portion 101. FIG. 3 illustrates a specific example of a structure of the panel input information. Referring to FIG. 3, specific panel input information basically includes information related to original document images (which may be referred to as “original images” hereinafter) to be processed, information related to the original images and output of image-related information, which will be described later, and information related to production of thumbnail image data, which is abbreviated image data produced from the original images. Also, the information related to the original images includes original image designation (e.g., scanning, or data in HDD 10) designating a source of the original image. In the case where the original image is to be obtained by scanning in scanner portion 102, the information related to the original images further includes a read resolution (i.e., image resolution in scanning), color instruction (color, monochrome, monochrome binary, two-tone color or automatic) in scanning, read side (single- or double-sided) representing the side(s) to be scanned, and read size (designated size or automatic) representing the size of the document to be scanned. The information related to the output includes a destination designation (IP address, E-mail address or the like), which is access information for a destination of the image-related information as well as designation (number of copies and size) related to print output (not illustrated). The information related to production of the thumbnail image data includes a thumbnail resolution (reduction rate), which is a resolution of the thumbnail images, a thumbnail region representing a region of original images, from which the thumbnail images are to be produced, color instruction (color, monochrome or monochrome binary) of the thumbnail images, and a thumbnail file format representing a file format of the thumbnail images.

Control portion 104 provides a control signal for executing the scanning to scanner portion 102 based on the panel input information entered via panel portion 101. Also, it provides a control signal for executing printing to printer portion 108.

Scanner portion 102 scans the original documents based on the control signal sent from control portion 104. When the original read size of the panel input information is “automatic”, and the control signal instructs free setting in scanner portion 102, scanner portion 102 determines the read size by detecting the size of the original document. When the original color destination in the panel input information is “automatic”, and the control signal instructs the free setting in scanner portion 102, scanner portion 102 determines the color instruction by detecting the color of the original document image.

Scanner portion 102 outputs scanner detection information, which represents the determined read size and the color instruction, to control portion 104, and control portion 104 provides the scanner detection information to image-related information producing portion 105 and output form instruction information producing portion 106. Scanner portion 102 also provides the image data obtained by scanning to control portion 104.

Control portion 104 compresses the scanned image data provided from scanner portion 102 by coding in JBIG (Joint Bi-level Image Experts Group) format, and provides the compressed data to data storing portion 103 for storage. Also, the image data stored in data storing portion 103 is sent to image-related information producing portion 105. Further, the image data stored in data storing portion 103 is sent to image output processing portion 107 for print output.

Data storing portion 103 stores the image data, the thumbnail image data, which will be described later, and the image-related information. The storage medium of data storing portion 103 may be formed of a Flash ROM, NVROM or the like instead of or in addition to foregoing HDD 10. It is preferable that information of a large data size such as image data is stored in a data storage device such as a hard disk, and information to be held even after powering off the apparatus is stored in a nonvolatile memory device such as a Flash ROM or a backup RAM such as NVRAM.

Image-related information producing portion 105 produces the image-related information, which includes the thumbnail image data corresponding to the image data, based on the panel input information provided from panel portion 101 via control portion 104, the scanner detection information provided from scanner portion 102 via control portion 104 and the image data stored in data storing portion 103.

The thumbnail images are abbreviated images produced by processing the image data obtained by scanner portion 102, and each formed by trimming or reducing the images obtained by scanning. The thumbnail image data is produced in a method designated by the panel input information, and image-related information producing portion 105 produces the thumbnail image data from the image data stored in data storing portion 103 in accordance with the designation by the panel input information provided from panel portion 101 via control portion 104. Image-related information producing portion 105 provides the thumbnail image data thus produced to data storing portion 103 for storage.

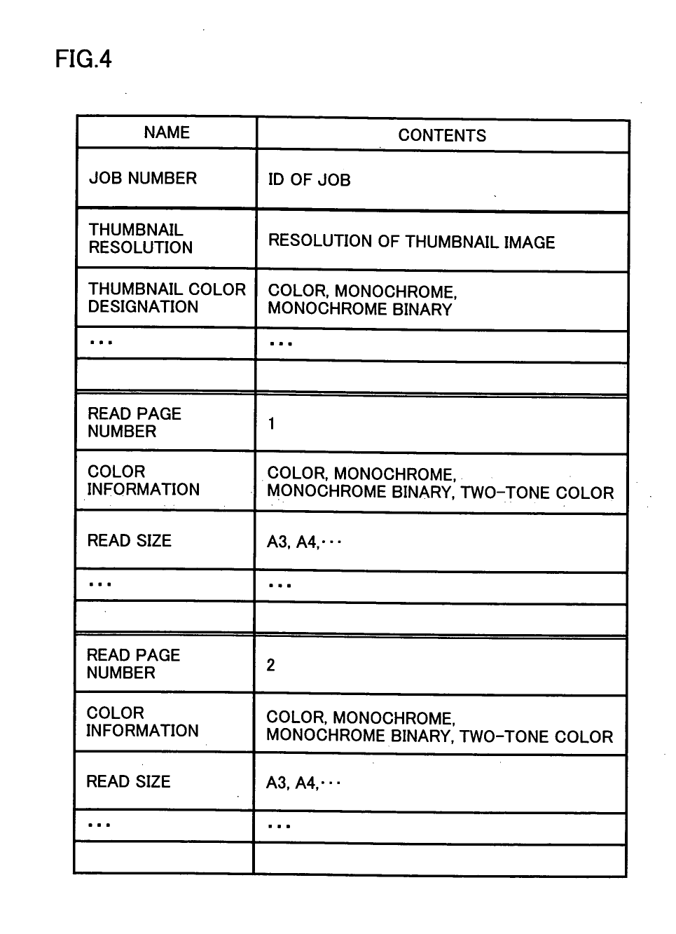

The image-related information relates to the image data. FIG. 4 illustrates a specific example of the structure of image-related information produced by image-related information producing portion 105. Referring to FIG. 4, the image-related information basically includes information related to one original document group forming a job unit, and information related to each original document forming the original document group. Further, the information related to the job includes a job number, which is identification information such as a job ID unique to the job, and information related to the thumbnail images. The information related to the thumbnail images includes a resolution (reduction ratio) of the thumbnail images, a thumbnail region representing a region of the original images, from which the thumbnail images are to be produced, color instruction (color, monochrome or monochrome binary) of the thumbnail images, and others. The information related to each original document includes a read page number, i.e., a page number of the original document in question, color information (color, monochrome, monochrome binary or two-tone color) of the original document, a read size (e.g., A3 or A4) of the original document and others. Although not illustrated in FIG. 4, the image-related information includes the thumbnail image data already described.

The image-related information produced by image-related information producing portion 105 is coupled to the thumbnail image data stored in data storing portion 103, and is stored in data storing portion 103. Under the control of control portion 104 receiving the panel input information from panel portion 101, image-related information producing portion 105 sends the image-related information via external interface portion 109 to personal computer 200, which is an external device designated as the destination according to the panel input information.

Output form instruction information producing portion 106 produces the output form instruction information based on the panel input information provided via control portion 104 from panel portion 101 as well as the read size and the color instruction provided via control portion 104 from scanner portion 102. Output form instruction information producing portion 106 may produce the output form instruction information by processing the image-related information stored in data storing portion 103 based on the panel input information provided via control portion 104 from panel portion 101.

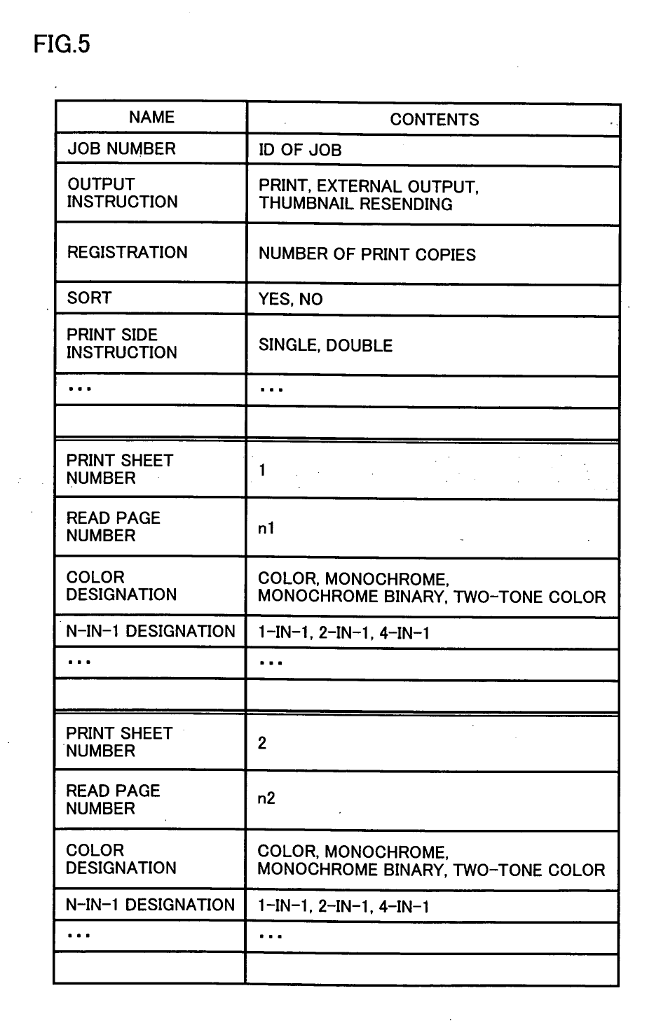

The output form instruction information instructs or designates the image data to be output and the manner of output, and thus instructs the output form of the image data. FIG. 5 illustrates a specific example of a structure of the output form instruction information produced by output form instruction information producing portion 106. Referring to FIG. 5, the output form instruction information basically includes information related to a job formed of the original document group, and information related to each output unit. The information related to the job includes a job number, which is identification information such as a job ID unique to the job, an output instruction representing a job output manner (e.g., print output, external output or resending of thumbnail images), a registration representing the number of outputs of the job, sort information representing whether the job is to be sorted or not, double-sided print instruction instructing double-sided print or single-sided print, and instructions (not illustrated) related to, e.g., a manner of binding. The information related to each output unit includes a print sheet number (i.e., print page number), which is a serial number of the output unit, a read page number representing a page number of the original document in the scanning operation of the image data to be output on the unit-by-unit basis, color instruction (color, monochrome, monochrome binary or two-tone color) of the output for each output unit, an N-in-1 instruction (1-in-1, 2-in-1 or 4-in-1) instructing the number of image data collected on each print sheet when printing the image data of each output unit, and others.

Depending on whether the output instruction of the job, which is included in the information related to the job in question, is print output by printer portion 108, external output to personal computer 200 or resending of the thumbnail images, output form instruction information producing portion 106 may produce the output form instruction information including the information for each output unit, which is different from the information for other output units. The information included for each output unit in the output form instruction information illustrated in FIG. 5 is a specific example of the output form instruction information, which is used when the output instruction of the job included in the information related to the job is the print output by printer portion 108. When the output instruction of the job is resending of the thumbnail images, output form instruction information producing portion 106 may produce the output form instruction information, in which information for each output unit includes information related to thumbnail images such as the resolution (reduction ratio) of thumbnail images, the thumbnail region, the color destination (color, monochrome or monochrome binary) of thumbnail images and others.

Regardless of whether the job output instruction included in the information related to the job is the print output by printer portion 108, the external output to personal computer 200 or the resending of thumbnail images, output form instruction information producing portion 106 may produce the output form instruction information, in which the information for each output unit includes information corresponding to all the output instructions, so that necessary information can be used in the output operation.

The output form instruction information producing portion 106 sends the output form instruction information produced thereby to image output processing portion 107 under the control of control portion 104 receiving the panel input information from panel portion 101. When external interface 109 obtains the output form instruction information from personal computer 200 (i.e., external device), it sends the output form instruction information thus obtained to image output processing portion 107.

Image output processing portion 107 processes the image data stored in data storing portion 103 based on the output form instruction information provided from output form instruction information producing portion 106 or external interface 109, and sends the processed data to printer portion 108. Printer portion 108 prints the processed image data provided from image output processing portion 107 based on the control signal provided from control portion 104.

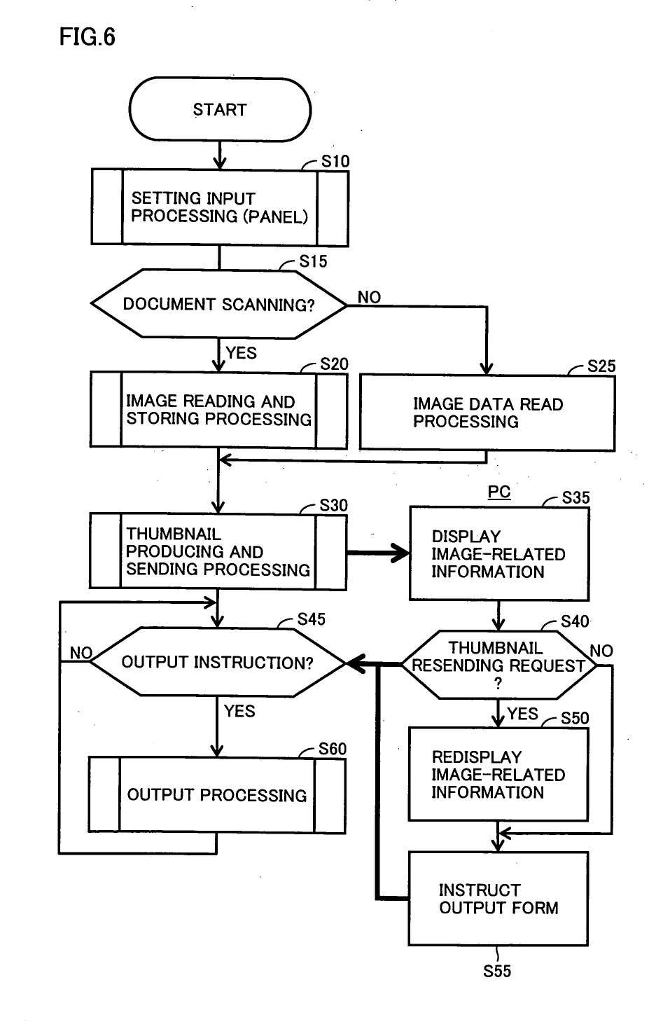

Referring to a flowchart of FIG. 6, description will now be given on the processing in the image forming system. The processing illustrated in FIG. 6 is performed by image forming apparatus 100 and personal computer 200, and is achieved by controlling the respective functions illustrated in FIG. 2. For this, CPU 11 of image forming apparatus 100 reads the programs, which are stored in ROM 13 or the like, and executes the read programs by developing them on RAM 12. The processing in personal computer 200 is likewise executed by CPU 21 of personal computer 200, which reads the programs stored in ROM 23 or the like, and executes the read programs by developing them on RAM 22.

Referring to FIG. 6, image forming apparatus 100 first accepts an operation on panel portion 101, and receives various settings (S10). The setting input processing in step S10 will be described later with reference to a subroutine.

Among the settings received in step S10, a setting related to the source of the original image to be processed may be determined such that the original image is to be obtained by scanning the original document with scanner device 17. In this case (YES at S15), the processing moves to a step S20, in which image reading and storing processing is performed. In the image reading and storing processing in step S20, an original document(s) is/are set on a document table or an ADF (Automatic Document Feeder) of scanner device 17, and console panel 18 is operated for selection of color/monochrome, designation of the read resolution and others. Then, an operator depresses a start key (not illustrated) on console panel 18 so that the image reading and storing processing starts. The image reading and storing processing in step S20 will also be described later with reference to a subroutine.

Among the settings provided in step S10, the setting related to the source of the original image may be determined such that the original image is to be obtained by accessing the record medium of data storing portion 103 such as HDD 10 of image forming apparatus 100 and reading the image data therefrom (NO at S15). In this case, the processing moves to a step S25, and the image data read processing is executed to read the intended image data from a predetermined storage region in step S25. The image data read processing in step S25 starts when the operator depresses the start key (not illustrated) on console panel 18 after the operator operates console panel 18 to perform required settings such as designation of the image data to be read in step S10.

Then, image forming apparatus 100 executes the thumbnail producing and sending processing (S30) to send the image-related information including the thumbnail images produced thereby from external interface 14 over network 500 to personal computer 200 set in step S10. The thumbnail producing and sending processing in step S30 will be described later with reference to a subroutine. When the thumbnail producing and sending processing is completed in step S30, it is determined whether the output form instruction information is present or not (S45).

Personal computer 200 receives the image-related information from image forming apparatus 100 via network 500 and external interface 24, and executes an application to display the received image-related information on display device 28 (S35). It may be difficult to instruct the output form based on the thumbnail images included in the image-related information, which is received from image forming apparatus 100. This situation occurs, e.g., when the images are unclear, or personal computer 200 failed the image reception. In this case, the output form instruction information requesting the resending of the image-related information including the thumbnail images is set to image forming apparatus 100 (YES at S40).

In step S40, personal computer 200 can request the resending of the thumbnail images already sent in step S30. In this case, personal computer 200 sends the output form instruction information requesting only the resending to image forming apparatus 100.

In step S40, personal computer 200 can request the resending of the thumbnail images, which are changed from the thumbnail images sent in step S30. In this case, the output form instruction information including the information, which relates to the production of the thumbnail images, is sent to image forming apparatus 100. More specifically, similarly to the information related to the production of thumbnail images in the panel input information, the thumbnail resolution (reduction ratio), which is the resolution of thumbnail images, the thumbnail region (i.e., the region in the original images) for producing the thumbnail images, color instruction (e.g., color, monochrome or monochrome binary) of the thumbnail images, the thumbnail file format (i.e., the file format of the thumbnail images) and others are sent to image forming apparatus 100.

When image forming apparatus 100 receives the output form instruction information, which is a request for resending of the thumbnail images, from personal computer 200 (YES at S45), it executes output processing in accordance with the information related to production of the thumbnail images and included in the output form instruction information (S60). In this output processing, the thumbnail images are produced again from the image data in data storing portion 103 in accordance with thumbnail producing conditions of the output form instruction information, and the image-related information including the thumbnail images is sent to personal computer 200. The output processing in step S60 will be described later with reference to a subroutine. When the output processing in step S60 is completed, the processing returns to step S45 for waiting for the output instruction sent from personal computer 200.

When personal computer 200 receives the image-related information resent from image forming apparatus 100, it executes an application to redisplay the resent image-related information on display device 28 (S50). Based on the image-related information displayed on display device 28 in step S35 or the image-related information redisplayed on display device 28 in step S50, the output form is processed to provide an output form such as “print output” intended by the user, and the output form instruction information instructing the output form is sent to image forming apparatus 100 (S55).

When image forming apparatus 100 receives the output form instruction information instructing the form of output from personal computer 200 (YES at S45), it executes the output processing in accordance with the instruction information similarly to the foregoing case (S60). When the output form instruction information instructing the output form has been produced by output form instruction information producing portion 106 (YES at S45), the output processing is executed in accordance with the instruction information similarly to the foregoing case (S60).

The image forming system performs the processing as described above.

According to the image forming system of this embodiment, as described above, when image forming apparatus 100 obtains the original image, the image data is not sent to personal computer 200, but the image-related information is sent to personal computer 200. Thereby, communication traffic can be smaller than that in the case where the image data is directly sent to personal computer 200, and a load on network 500 can be suppressed. Further, an available storage capacity of personal computer 200 is not suppressed.

According to the image forming system of the embodiment, image forming apparatus 100 sends the image-related information to personal computer 200 designated as the destination in the image-related information. This can improve convenience of the user instructing the output form.

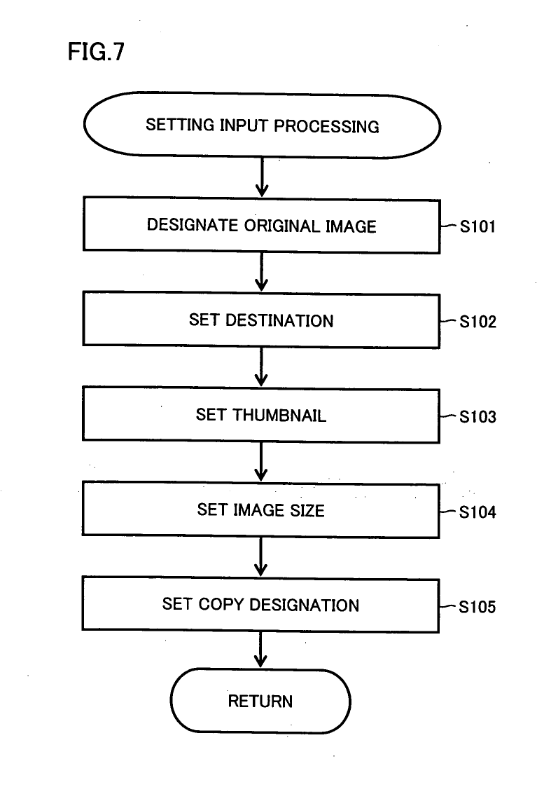

Description will now be given on the setting input processing executed by image forming apparatus 100 in step S10 with reference to a flowchart of FIG. 7. By executing the setting input processing in step S10, the panel input information illustrated in FIG. 3 is produced.

Referring to FIG. 7, setting is performed to designate the source of the original images for producing the thumbnail images (S101). Specific contents of the setting in step S101 represent scanner portion 102 or HDD 10. The information set in this step corresponds to the “original image designation” of the panel input information illustrated in FIG. 3.

Then, setting is performed to designate the destination of the formed thumbnail images (S102). Specific contents of the setting in step S102 represent a mail address, IP address, device name of personal computer 200 or the like. The information thus set corresponds to the “destination designation” of the panel input information illustrated in FIG. 3. Step S102 may be configured not to set the designation of the destination. Thereby, the thumbnail images can be prepared first, and thereafter the destination may be set for sending them.

Then, designation relating to the thumbnail image is set (S103). Specific contents of setting in step S103 represent whether the thumbnail images of the original image is to be formed or not, and also represent the resolution and size of the thumbnail image to be produced. The information thus set corresponds to the “thumbnail resolution”, “thumbnail region”, “thumbnail color designation” and others, which are included in the panel input information illustrated in FIG. 3 and relates to the production of the thumbnail image data.

Then, the size and others of the original image to be scanned are set (S104). Specific contents of setting in step S104 represent the image read resolution, color of the original document (i.e., color or monochrome), single-sided reading or double-sided reading, read size and others. The information thus set corresponds to the “read resolution”, “color instruction”, “read side” and others, which are included in the panel information illustrated in FIG. 3 and relate to the original image.

Then, the copy output instruction is set (S105). Specific contents of setting in step S105 represent whether the original image is to be output by printing or not, and also represent the number of copies and size of the print output.

In this manner, the setting input processing in step S10 is completed, and the processing returns to the main routine illustrated in FIG. 6.

In foregoing steps S101-S105, it is not essential to execute all the processing, and it is merely required to execute only the required processing depending on the source or the original image and the output form. For example, if the original image is obtained by reading it from HDD 10, setting processing in step S104 is not required, and step S104 may be skip.

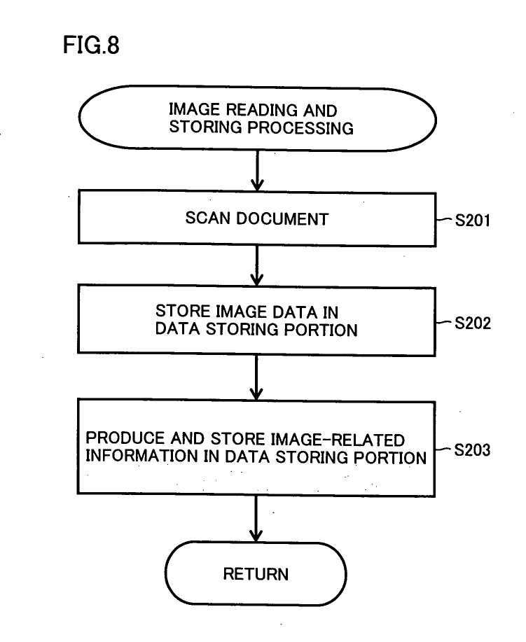

The image reading and storing processing executed by image forming apparatus 100 in step S20 already described will now be described with reference to a flowchart of FIG. 8.

Referring to FIG. 8, each of the original documents in the document group is processed in accordance with the setting contents in step S10 so that CCD reads the document laid on the document table, or reads the documents, which are set in the ADF and are successively fed therefrom (S201). In this operation, scanner portion 102 detects the size and color of the original document, if necessary, and sends the scanner-detected information to control portion 104. The image data of the document group read in step S201 is compressed, and is sent to data storing portion 103 for storage (S202).

Then, image-related information producing portion 105 produces the image-related information illustrated in FIG. 4 based on the panel input information, which is produced by the setting input processing in step S10 and is provided from panel portion 101 via control portion 104, as well as the scanner-detected information provided via control portion 104 from scanner portion 102 in step S201 (S203).

By the processing described above, the image reading and storing processing in step S20 is completed, and the processing returns to the main routine illustrated in FIG. 6.

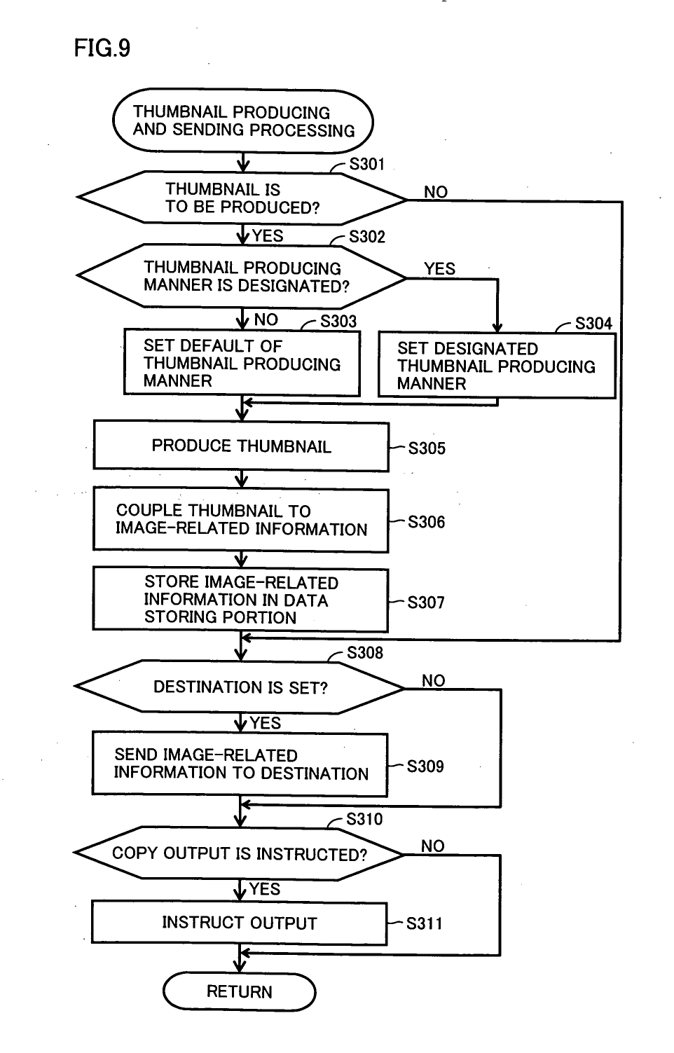

The thumbnail producing and sending processing executed by image forming apparatus 100 in step S30 will now be described with reference to a flowchart of FIG. 9. The thumbnail producing and sending processing illustrated in the flowchart of FIG. 9 is executed when it is determined in step S15 from the panel input information that the original image is to be obtained by scanning in scanner portion 102 (YES at S15).

Referring to FIG. 9, image-related information producing portion 105 first determines whether the thumbnail image is to be produced or not (S301), based on the panel input information which is produced by the setting input processing in step S10, and is provided via control portion 104 from panel portion 101. When the production of the thumbnail image is not necessary (NO at S301), steps S302-S307 are skipped, and the processing moves to a step S308.

When it is determined in step S301 that the thumbnail image is to be produced (YES at S301), image-related information producing portion 105 further determines whether the manner of producing the thumbnail image is designated in the panel input information or not (S302). When the thumbnail image producing manner is not designated in the panel input information (NO at S302), image-related information producing portion 105 sets defaults designating the thumbnail image producing manner relating to the image size, resolution and others in the internal data (S303). When the panel input information includes the destination of the thumbnail image producing manner (YES at S302), the designation of the thumbnail image producing manner relating to the image size, resolution and others is read from the panel input information, and is set in the internal data (S304).

Then, in accordance with the thumbnail image producing manner, which relates to the image size, resolution and others, and is set in step S303 or S304, image-related information producing portion 105 produces the thumbnail image of each original document from the image data of each original document stored in data storing portion 103 (S305). The manner of producing the thumbnail images in step S305 is not restricted in the invention, and various techniques, which have been widely employed, can be employed for the producing the thumbnail images.

Further, image-related information producing portion 105 couples the thumbnail image produced in step S305 to the image-related information produced by the image reading and storing processing in step S20 already described, and thereby produces new image-related information (S306). The image-related information producing portion 105 sends the image-related information, which includes the thumbnail image and is produced in step S306, to data storing portion 103 for storage (S307).

For using the thumbnail image in a step S55, which will be described later in detail, it is most preferable that the image-related information includes the thumbnail image produced from the original document data. However, it is not essential that the image-related information includes the thumbnail image produced from the original document data, and may include, instead of the thumbnail image, another kind of information which can visually represent the original document data when display device 28 of personal computer 200 displays the image-related information in step(s) S35 and/or S50. As the most simple and specific example of the above information other the thumbnail image, it is possible to employ at least one item in the image-related information, which is produced in the image reading and storing processing in step S20, such as characters (numbers) representing the reading order or graphics bearing the numbers representing, e.g., the reading order.

Then, image-related information producing portion 105 determines whether the panel input information includes the designation of the destination of the image-related information (S308). When the panel input information does not include the designation of the destination of the image-related information (NO at S308), the processing skips a step S309, and moves to a step S310. When the panel input information includes the designation of the destination. of the image-related information (YES at S308), the designation of the destination is read from the panel input information, and the image-related information stored in data storing portion 103 is sent to the designated destination via external interface 109 in a sending manner (e.g., E-mail or FTP (File Transfer Protocol)) appropriately corresponding to the destination (S309). A specific example of the data of the image-related information sent in step S309 is already described with reference to FIG. 4, and the form thereof is not restricted in the invention. For example, such forms can be selected that all the image-related information relating to the respective original documents, which form one document group handled as one job, forms one file, that the image-related information other than the thumbnail images forms one file, and the thumbnail images form the other file (i.e., two files are prepared), and that two files (one including the information common as a job to one original document group and the other including information unique to each document (page) forming the original document group) are employed similarly to the specific example in FIG. 4.

Then, output form instruction information producing portion 106 determines whether the panel input information includes the copy output instruction or not (S310). When the panel input information does not include the copy output instruction (NO at S310), a step S311 is skipped, the thumbnail producing and sending processing in step S30 ends, and the processing returns to the main routine in FIG. 6. When the panel input information includes the copy output instruction (YES at S310), output form instruction information producing portion 106 produces the output form instruction information, which instructs the print output, and sends it to image output processing portion 107 under the control of control portion 104 for instructing the output (S311). The output form instruction information produced in step S311 may be sent to the destination of the image-related information, which is designated in the panel input information, together with the image-related information or in the form coupled to the image-related information. In this case, the output form instruction information sent from image forming apparatus 100 can be processed in processing, which is performed by personal computer 200 for producing the output form instruction information as will be described later.

By the processing described above, the thumbnail producing and sending processing is completed, and the processing returns to the main routine illustrated in FIG. 6.

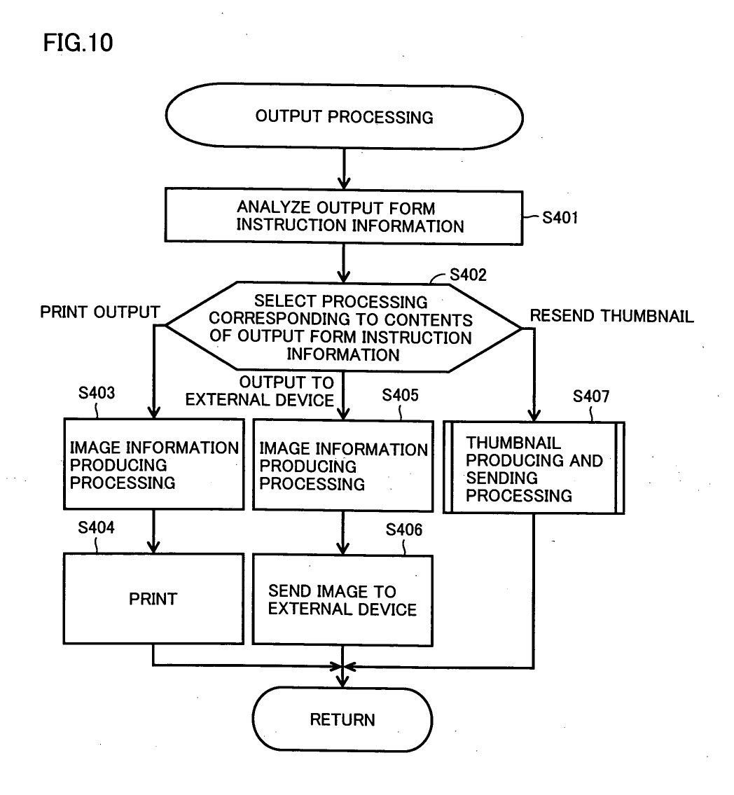

The output processing executed by image forming apparatus 100 in step S60 will now be described with reference to a flowchart of FIG. 10. The output processing illustrated in the flowchart of FIG. 10 is executed when image output processing portion 107 receives the output form instruction information from output form instruction information producing portion 106 in foregoing step S30, or receives the output form instruction information via external interface portion 109 from personal computer 200, and it is determined that the output form instruction information is present (YES at S45).

Referring to FIG. 10, image output processing portion 107 first analyzes the received output form instruction information (S401), and selects the processing corresponding to contents of the output form instruction information (S402).

When it is determined from the analysis in step S401 that the output form instructed in the output form instruction information is print output (“print output” at S402), image output processing portion 107 reads the image data to be printed from data storing portion 103, and processes it in accordance with the output form instruction information (S403). The image data thus processed is sent from image output processing portion 107 to printer portion 108, which executes the print output (S404).

When it is determined from the analysis in step S401 that the output form instructed in the output form instruction information is output to the external device (“output to external device” at S402), image output processing portion 107 reads the image data to be output to the external device from data storing portion 103, and processes it in accordance with the output form instruction information (S405). The image data thus processed is sent from image output processing portion 107 via external interface portion 109 to the external device (S406), and the processing of output to the external device ends.

When it is determined from the analysis in step S401 that the output form instructed in the output form instruction information is resending of the image-related information including the thumbnail image (“thumbnail resending” at S402), image-related information producing portion 105 executes the thumbnail producing and sending processing already described, and sends the image-related information thus produced to the designated external device (S407). The instruction of the output form in the output form instruction information, which instructs the resending, is not restricted to the resending of the image-related information, and may be configured to instruct the resending of only the thumbnail image. In this case, only the processing of producing the thumbnail image is executed as the thumbnail producing and sending processing in step S407, and the file of the thumbnail image thus produced is sent to the external device.

By the processing described above, the output processing in step S60 is completed, and the processing returns to the main routine illustrated in FIG. 6.

In the steps S50 and S55, as already described, personal computer 200 executes the application to display the image-related information received from image forming apparatus 100 on display device 28, and the output form is instructed by using the displayed image-related information. A manner of this processing will now be described with reference to a specific example.

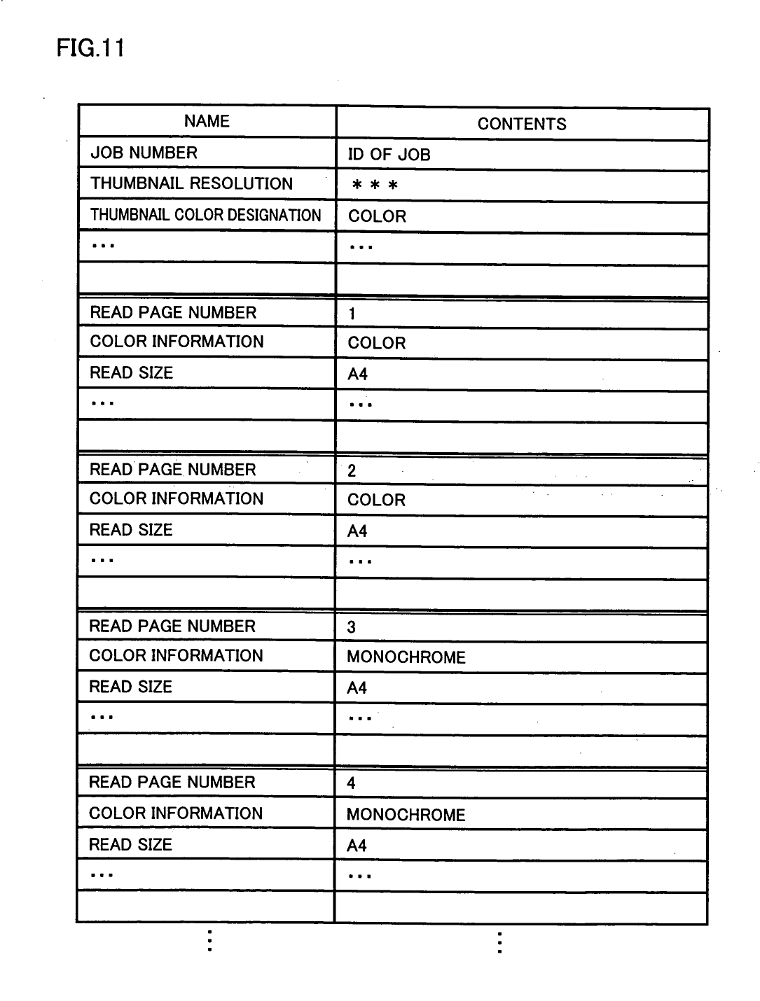

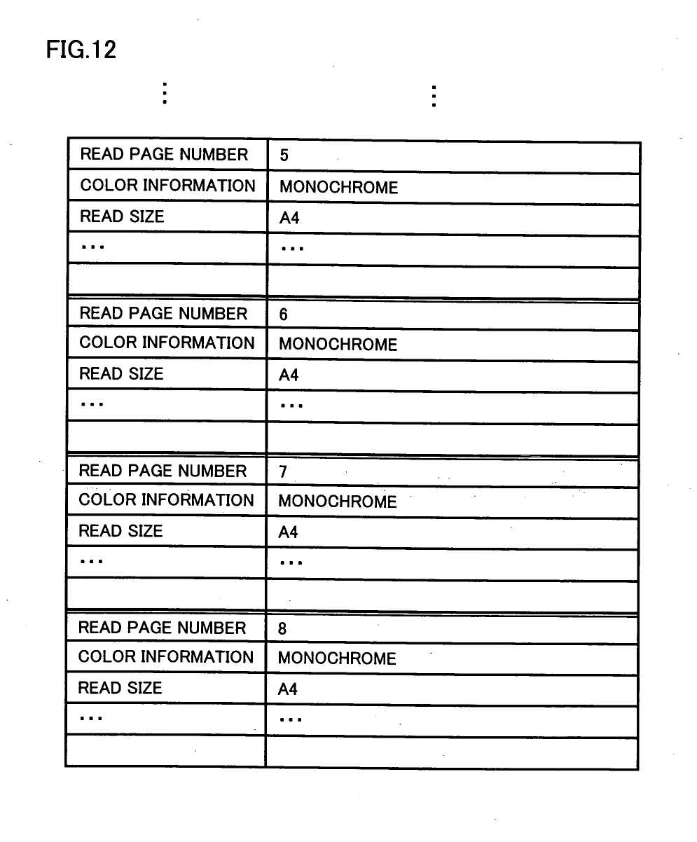

It is assumed that personal computer 200 has received from image forming apparatus 100 the image-related information illustrated in FIGS. 11 and 12 as well as the image-related information including the thumbnail images (not illustrated) of the respective original documents. The image-related information illustrated in FIGS. 11 and 12 relates to the job for the document group formed of original documents bearing the read page numbers 1-8, respectively. According to the image-related information, the read size for all the documents is A4. Further, the color information of the documents bearing the read page numbers 1 and 2 are “color”, and the color information of the documents for the other read page numbers 3 to 8 are “monochrome”. The color designation of the thumbnail image of each document is “color”.

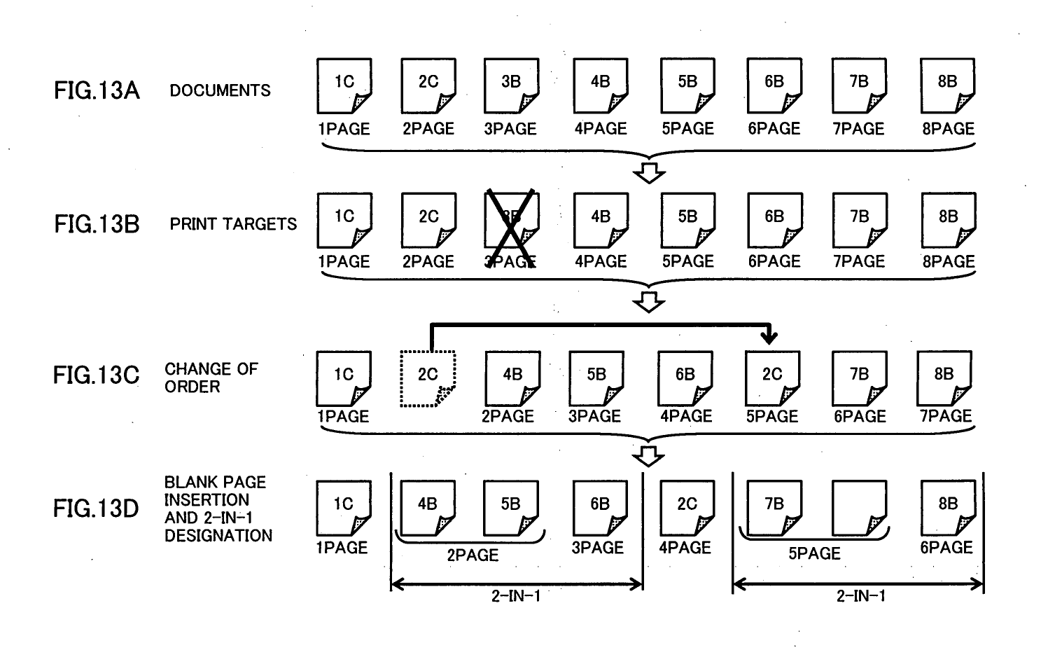

When personal computer 200 executes the application, display device 28 performs the screen display, of which specific examples are illustrated in FIGS. 13A-13D. When personal computer 200 receives the image-related information, which is illustrated in FIGS. 11 and 12, and includes the thumbnail images (not illustrated) of the respective documents, from image forming apparatus 100, display device 28 executes the thumbnail display illustrated in FIG. 13A. More specifically, as illustrated in FIG. 13A, display device 28 displays, in color, thumbnail images of the eight documents forming the original document group as well as information representing attributes thereof in the order of output. In FIG. 13A, the read page number and the color information “C” or “B” representing “color” or “monochrome” are displayed as the information representing the attributes of each document.

For example, when the pages 1 and 2 include chapter titles and index, it is preferable for easy viewing that the chapter titles are arranged in the leading page of the chapter, and it is convenient that a blank page for a memo is present, if necessary. Therefore, the following output form instruction can be selected.

(1) The documents of read page numbers 1, 2, 4, 5, 6 and 7 are handled as the print output targets. (Thus, the document of read page number 3 is not printed out.)

(2) The document of read page number 2 is moved to a fifth position in the output order.

(3) A blank page is inserted between the documents of read page numbers 7 and 8.

(4) The documents of read page numbers 4, 5 and 6 are printed out in 2-in-1 (i.e., in the form including two pages on a single sheet).

(5) The documents of read page numbers 7 and 8 as well as the blank page inserted between the documents of read page numbers 7 and 8 are printed out in 2-in-1.

(6) Two copies of the document groups are printed out in a sorted fashion.

In this situation, personal computer 200 accepts entry of the instructions via input device 27 (e.g., mouse and keyboard), when display device 28 is displaying the thumbnails as illustrated in FIG. 13A.

More specifically, the operation of designating the print targets in the above item (1) is executed on the displayed thumbnail images of the respective documents illustrated in FIG. 13B by clicking the mouse on the thumbnail image of the document (i.e., the document of read page number 3) other than the print targets. Conversely, the operation may be executed to select the documents of the print targets (i.e., the documents of read page numbers 1, 2, 4, 5, 6, 7 and 8), e.g., by mouse clicking. FIG. 13B illustrates a specific example of the thumbnail display by display device 28 after the above selection. In FIG. 13B, the thumbnail image of the document of read page number 3, which is selected as the document not to be printed, is displayed in a form different from that of the thumbnail images of the other documents so that the document other than the print targets can be clearly understood.

The operation in the above item (2) for changing the output order is executed, as illustrated in FIG. 13C, on the displayed thumbnail images of the respective documents, e.g., by dragging the thumbnail image (i.e., the document of read page number 2), of which output order is to be changed, with the mouse. FIG. 13C illustrates a specific example of the thumbnail display on display device 28 after the above operation. In FIG. 13C, the thumbnail image of the document of read page number 2, which was dragged with the mouse for changing the output order, is displayed in the intended output position, i.e., the fifth output position.

The operation in the above item (3) for inserting the blank page is executed in such a manner that the mouse is double-clicked on a position, where the blank page is to be inserted, and thus, on the position between the thumbnail images of the documents of read page numbers 7 and 8 in FIG. 13C. Alternatively, an appropriate pop-up menu may be displayed in the above intended position, and a command of instructing insertion of the blank page may be selected on the pop-up menu.

The operations in the above items (4) and (5) for designating the 2-in-1 is execute, e.g., as follows. Referring to FIG. 13D, the thumbnail images of the documents for the 2-in-1 printing (i.e., the documents of read page numbers 4, 5, 6, 7 and 8 as well as the blank page inserted between the documents of read page numbers 7 and 8) are selected, e.g., by mouse-click from the displayed thumbnail images of the respective documents, and then, an appropriate pop-up menu is displayed, and a command designating the 2-to-1 is selected on the menu. FIG. 13D illustrates a specific example of the thumbnail display by display device 28 after the above operation. The thumbnail image representing the blank page is displayed between the thumbnail images of the documents of read page numbers 7 and 8. The documents of read page numbers 4, 5, 6, 7 and 8 as well as the blank page inserted between the documents of read page numbers 7 and 8 are already selected as the targets of the 2-in-1 printing as described above, and the display is performed in FIG. 13D to represent that these documents and page are the targets of 2-in-1 printing are displayed near the thumbnail images of these target documents and page.

The operation in the above item (6) for designating the output form of the job is performed, e.g., by using a menu screen (not illustrated) and entering through the keyboard or mouse that the output form is the print output, the number of copies of outputs is two and the sort is necessary.

The manners described above are merely examples of the manners of operations of instructing the output form by using the thumbnail images, and the operation manners in the invention are not restricted to the above. Naturally, the output form instructed in personal computer 200 is not restricted to the form already described, and another output form may be instructed.

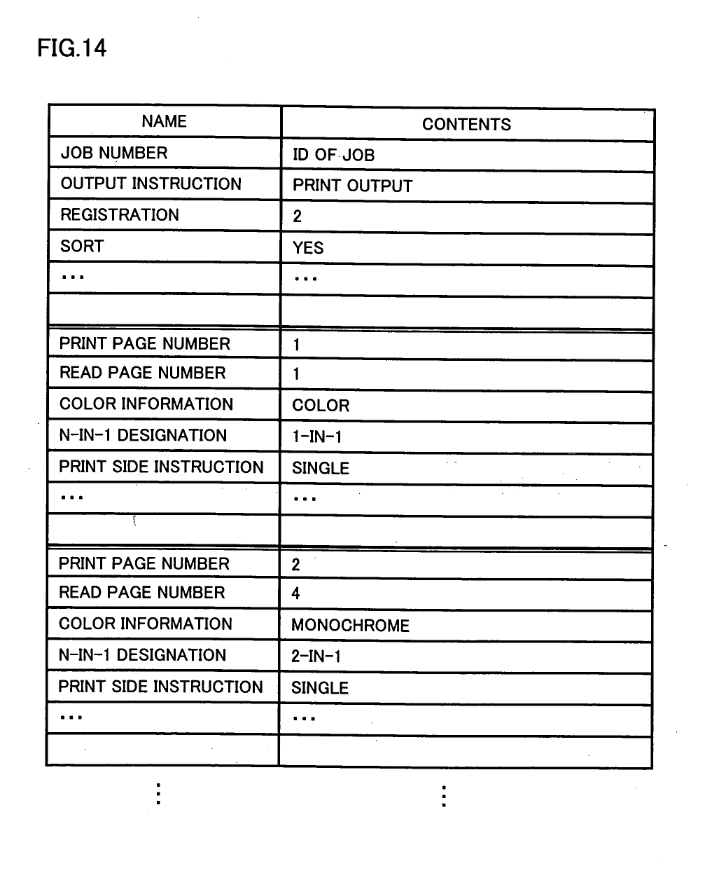

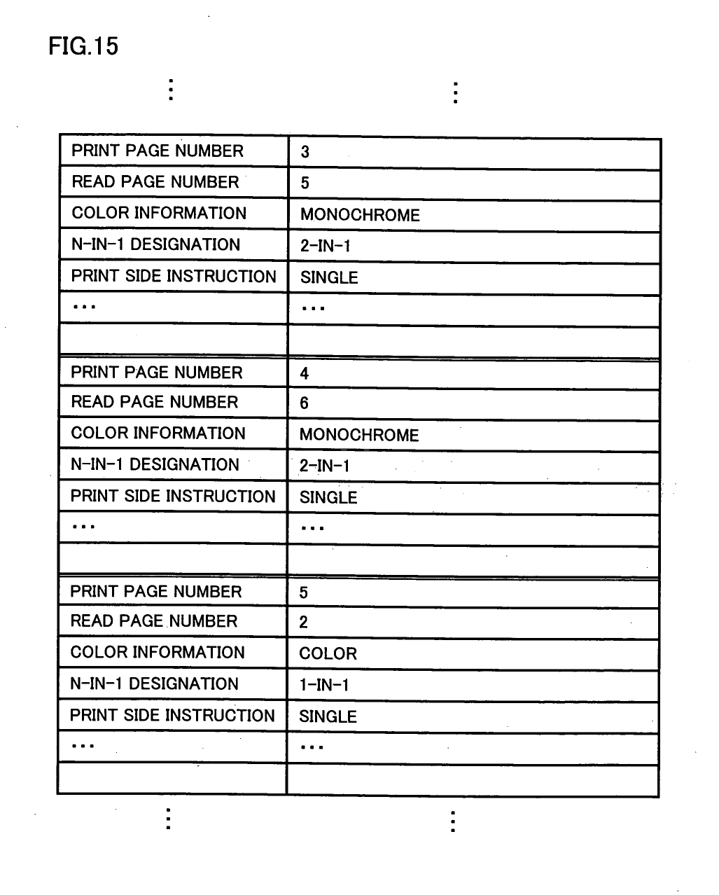

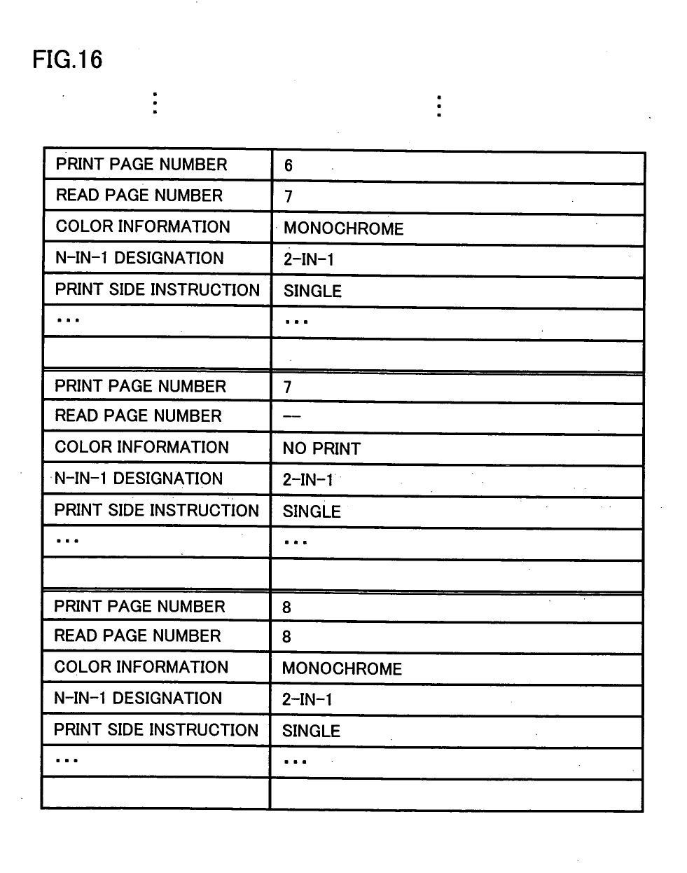

In response to the foregoing instruction input via input device 27, personal computer 200 executes the application to produce the output form instruction information from the image-related information received from image forming apparatus 100. FIGS. 14 to 16 illustrate specific examples of the output form instruction information produced from the image-related information illustrated in FIGS. 11 and 12.

Referring to FIG. 14, information instructing the output form of the job is produced based on the job number included in the image-related information illustrated in FIG. 11 and the operation of designating the output form of the job in the above item (6). In the order of output, information instructing the output form of the document is produced for each output page.

More specifically, the document in the first output position is the document of read page number 1, and thus is the same as the first document in the read order of the image-related information. The foregoing operations for the color instruction and N-in-1 designation were not performed for this document so that the attributes of this document in the image-related information have been designated as they are. Further, the foregoing operation for the print side(s) was not performed so that the default of single-sided printing is already instructed.

For the documents in the second to fourth output positions, the operation of designating them in the above item (1) as the print targets was performed, and also the operation of changing the output order in the above item (2) was performed. Therefore, the documents of read page numbers 4 to 6 are designated as the documents in the second to fourth output positions, and the 2-in-1 designation is already selected as the N-in-a designation by the operation of designating the 2-in-1 in the above item (4).

The document in the fifth output position is formed of the document of reading page number 2 as a result of the operation of changing the output order in the foregoing item (2).

The document in the sixth output order is formed of the document of read page number 7 as a result of the operation of designating the print target in the foregoing item (1). For the document in the seventh output position, the operation of inserting the blank page in the foregoing item (3) is performed so that the read page is not specified, “no print” is designated in the color instruction and thus the blank page is instructed. The document in the eighth output position is the document of read page number 8, and thus the position is not changed from that in the read order of the image-related information. For the documents in the sixth to eighth output positions, the operation of designating 2-in-1 in the foregoing item (5) was performed so that the 2-in-1 designation is already selected as the N-in-1 designation.

In steps S50-S55, personal computer 200 executes the foregoing processing to produce the output form instruction information, and sends it to image forming apparatus 100.

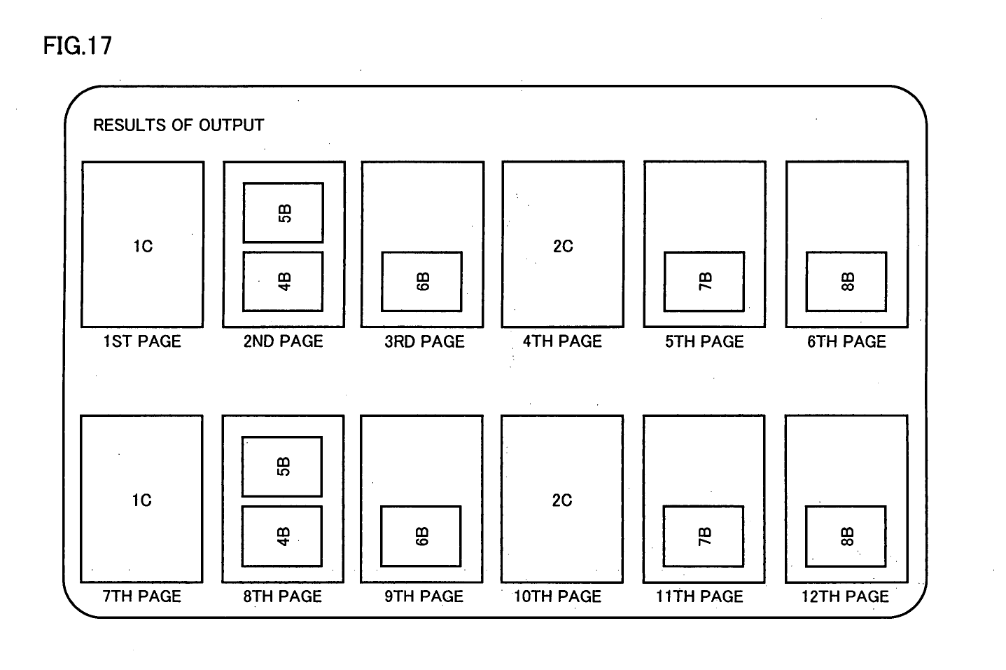

Image forming apparatus 100, which received the output form instruction information illustrated in FIGS. 14 to 16 from personal computer 200, executes the output processing in step S60 so that it produces the image information for print output based on the output form instruction information in step S403, and executes the print output in step S404 as illustrated in FIG. 17. FIG. 17 schematically illustrates results of the print output performed by image forming apparatus 100 when the output form instruction information illustrated in FIGS. 14 to 16 are employed as the output form instruction information. Prior to the print output in step S404, console panel 18 of image forming apparatus 100 and display device 28 of personal computer 200 performing the output form instruction may display on their screens the thumbnails for confirmation as illustrated in FIG. 17.

As described above, image forming apparatus 100 according to an embodiment of the invention sends the image-related information including the thumbnail images, which are produced from the image data of respective scanned original documents, to the designated destination, i.e., personal computer 200. Therefore, the output form can be instructed page by page on personal computer 200 by using the thumbnail images each formed of a reduced document or a partial image.

Further, the image forming method executed by foregoing image forming apparatus 100 and the foregoing method of instructing the output form by personal computer 200 can be provided or supplied in the form of programs. Such programs may be supplied by recording them on computer-readable record mediums such as flexible discs, CD-ROMs (Compact Disc-Read Only Memory), ROMs, RAMs and/or memory cards of or for the computers. Also, the programs may be supplied by storing them on record mediums such as hard discs arranged within the computers. Further, the programs may be supplied by downloading over the networks.

A program product thus supplied is installed on a program storage portion such as a hard disc for execution. The program product includes the program itself and a record medium storing the program.

Although the present invention has been described and illustrated in detail, it is clearly understood that the same is by way of illustration and example only and is not to be taken by way of limitation, the spirit and scope of the present invention being limited only by the terms of the appended claims.

1. An image forming apparatus comprising:
a holding portion holding obtained image data;
an image-related information producing portion producing image-related information related to said image data;
an accepting portion accepting designation of a destination of said image-related information to be sent;
a sending portion sending said image-related information to an external device at said designated destination;
a receiving portion receiving output form instruction information related to said image data from said external device; and
an image forming portion forming image data for output from said image data held by said holding portion based on said output form instruction information.

2. The image forming apparatus according to claim 1, wherein
said image-related information producing portion produces the image-related information including an abbreviated image prepared from at least a part of said image data.

3. The image forming apparatus according to claim 1, wherein
said receiving portion receives, as an output form, said output form instruction information instructing either print output of said image data or sending output of said image data to another device.

4. The image forming apparatus according to claim 1, wherein
said image data is obtained by scanning each of documents forming a document group,
said image-related information producing portion produces said image-related information for each of said documents, and
said receiving portion receives said output form instruction information instructing an output form of each of said documents.

5. An image forming apparatus comprising:
a holding portion holding obtained image data;
an accepting portion accepting a setting from an external device, said setting being related to an abbreviated image prepared from said image data;
an abbreviated image producing portion producing said abbreviated image by using at least a part of said image data based on said setting; and
a sending portion sending said abbreviated image to said external device.

6. The image forming apparatus according to claim 5, wherein
said accepting portion accepts said setting designating at least one of a resolution of said abbreviated image, a color of said abbreviated image, a data format of said abbreviated image and a region of said image data to be used for producing said abbreviated image.

7. The image forming apparatus according to claim 5, wherein
said setting accepted by said accepting portion from said external device designates at least one of change of said abbreviated image and resending of said abbreviated image.

8. An image forming method comprising:
a storing step of storing obtained image data in a storage device by an image forming apparatus;
an image-related information producing step of producing image-related information related to said image data in said image forming apparatus;
a designating step of designating to said image forming apparatus, a destination of said image-related information to be sent;
an image-related information sending step of sending said image-related information to an image managing apparatus at the designated destination from said image forming apparatus;
an image-related information displaying step of displaying, in said image managing apparatus, the image-related information received from said image forming apparatus;
an output form instruction information producing step of producing, in said image managing apparatus, output form instruction information related to said image data;
an output form instruction information sending step of sending said output form instruction information from said image managing apparatus to said image forming apparatus; and
an image forming step of forming image data for output from said image data stored in said storage device based on said output form instruction information.

9. An image forming method comprising:
a storing step of storing obtained image data in a storage device by an image forming apparatus;
a setting step of effecting a setting related to an abbreviated image to be produced from said image data on said image forming apparatus by an image managing apparatus;
an abbreviated image producing step of producing, in said image forming apparatus, said abbreviated image by using at least a part of said image data based on said setting; and
a sending step of sending said abbreviated image from said image forming apparatus to said image managing apparatus.

10. An image forming method comprising:
a storing step of storing obtained image data in a storage device by an image forming apparatus;
a first abbreviated image producing and sending step of producing a first abbreviated image by using at least a part of said image data, and sending said first abbreviated image from said image forming apparatus to an image managing apparatus;
an instructing step of sending an instruction related to said first abbreviated image from said image managing apparatus to said image forming apparatus; and
a second abbreviated image producing and sending step of producing, in said image forming apparatus, a second abbreviated image to be substituted for said first abbreviated image by using at least a part of said image data based on said instruction, and sending said second abbreviated image.

11. An image managing apparatus comprising:
a receiving portion receiving image-related information related to image data from an image forming apparatus;
a display portion displaying said image-related information;
an output form instruction information producing portion producing output form instruction information instructing an output form of said image data held in said image forming apparatus based on said image-related information; and
a sending portion sending said output form instruction information to the image forming apparatus.

12. The image managing apparatus according to claim 11, wherein
said image-related information includes an abbreviated image prepared from at least a part of the image data,
said display portion displays at least said abbreviated image, and
said image managing apparatus further comprises an accepting portion accepting an instruction operation using said abbreviated image and performed by a user for an output form.

13. The image managing apparatus according to claim 11, wherein
said output form instruction information producing portion produces, as said output form, the output form instruction information instructing either print output of said image data or sending output of said image data to another device.

14. The image managing apparatus according to claim 11, wherein
said image data is obtained by scanning each of documents forming a document group,
said image-related information received from said image forming apparatus includes the image-related information for each of said documents, and
said output form instruction information producing portion produces said output form instruction information instructing an output form of each of said documents.

15. An image managing apparatus comprising:
a receiving portion receiving an abbreviated image produced by using at least a part of image data from an image forming apparatus; and
a sending portion sending instruction information providing an instruction related to said abbreviated image.

16. The image managing apparatus according to claim 15, wherein
said instruction related to the abbreviated image instructs at least one of change of said abbreviated image and resending of said abbreviated image.

17. The image managing apparatus according to claim 15, wherein
said instruction related to the abbreviated image instructs at least one of a resolution of said abbreviated image, a color of said abbreviated image, a data format of said abbreviated image and a region of said image data to be used for producing said abbreviated image.
